(19) United States
(12) Patent Application Publication
(10) Pub. No.: US 2021/0162669 A1
(43) Pub. Date: Jun. 3, 2021

(54) THREE-DIMENSIONAL OBJECT MANUFACTURING DEVICE AND METHOD

(71) Applicant: FUJI CORPORATION, Chiryu (JP)

(72) Inventors: Joji ISOZUMI, Sunnyvale, CA (US); Kenta HAGIHARA, Kasugai-shi (JP)

(73) Assignee: FUJI CORPORATION, Chiryu (JP)

(21) Appl. No.: 17/047,985

(22) PCT Filed: May 25, 2018
(86) PCT No.: PCT/US18/34670

§ 371 Date: Oct. 15, 2020

(51) Int. Cl. B29C 64/268; B29C 64/135

(52) U.S. Cl. CPC B29C 64/268; B33Y 50/02; B29C 64/135

(57) ABSTRACT

A three-dimensional object manufacturing device and method including a vat configured to hold a photopolymer; a digital light processing unit configured to apply light to at least a portion of the photopolymer in the vat so as to create a layer of a three-dimensional object; a movable stage configured to be movable relative to the vat containing the photopolymer; a moving device configured to move the stage; and a controller configured to control a speed of the moving device based on a torque value of the moving device.

### FIELD OF THE DISCLOSURE

The present application relates to a three-dimensional object manufacturing device and method using digital light processing (DLP), more specifically a three-dimensional object manufacturing device and method using digital light processing with circuitry for controlling a stage of the manufacturing device based on a torque value of a moving device for moving the stage.

### DESCRIPTION OF THE RELATED ART

Various methods and devices for forming three-dimensional (“3D”) objects using printing techniques have been proposed. For example, 3D printers that use digital light processing (DLP) technology to form 3D objects are well known. With such devices, a stage is placed in a vat filled with a photopolymer and light is applied through the bottom of the vat to a cross-sectional area of the photopolymer, so as to create a layer of a desired three-dimensional object attached to the stage. The stage is then raised slightly and processing repeated until all layers of the object have been created. Such devices have benefits including fast processing speed, relatively high accuracy, and relatively little waste generated.

However, there is room for improvement in the effectiveness of such devices. For example, Published Patent Application JP 2015-024634A (“JP '634”) discusses features to suppress falling of a three-dimensional molded object in the middle of production from a member holding the molded object, but lacks detailed discussion regarding processing accuracy and speed

Also, for example, U.S. Pat. No. 8,623,264 B2 (“U.S. Pat. No. '264”) outlines a method and device in which a trough (vat) can be shifted horizontally, or in which multiple vats arranged on a turntable can be moved in a circle. Further, U.S. Pat. No. '264 describes a method of controlling forces on a build platform (stage) during processing. However, methods outlined for measuring and controlling forces are relatively complex, leaving room for improvement in terms of a simple configuration that maintains processing effectiveness.

Further, for example, United States Patent Application Publication US2017/368747A1 (“US '747”) discusses techniques for determining an accurate position of a build platform (stage), for example, by measuring forces, but does not discuss implications for processing speed, thus leaving room for improvement in terms of processing effectiveness.

### SUMMARY

A DLP 3D printer with improved processing effectiveness that solves the above problems is desired. For this, the inventors propose a three-dimensional object manufacturing device including:

a vat configured to hold a photopolymer;

a digital light processing unit configured to apply light to at least a portion of the photopolymer in the vat so as to create a layer of a three-dimensional object;

a movable stage configured to be movable relative to the vat containing the photopolymer;

a moving device configured to move the stage; and

a controller configured to control a speed of the moving device based on a torque value of the moving device.

The inventors further propose a three-dimensional object manufacturing method including:

filling a vat with a photopolymer;

applying light using a digital light processing unit to at least a portion of the photopolymer in the vat so as to create a layer of a three-dimensional object;

using a moving device to move a movable stage relative to the vat containing the photopolymer; and

controlling a speed of the moving device based on a torque value of the moving device.

According to both the device and method above, the speed at which a movable stage is moved relative to a vat containing a photopolymer used to create a three-dimensional object can be controlled based on a torque value of a moving device that moves the stage. This allows for efficient and effective printing processing while preventing a workpiece from falling during printing processing.

### BRIEF DESCRIPTION OF THE SEVERAL VIEWS OF THE DRAWINGS

FIG. 1 is a schematic view of a printer, according to certain aspects of the disclosure.

FIG. 2 is a block diagram showing the overall configuration of a printer, according to certain aspects of the disclosure.

FIG. 3 is a table showing an example of work data, according to certain aspects of the disclosure.

FIG. 4 is a flowchart showing an example of printing processing, according to certain aspects of the disclosure.

### DETAILED DESCRIPTION

Materials, methods, and examples discussed herein are illustrative only and are not intended to be limiting. In the drawings, like reference numerals designate identical or corresponding parts throughout the several views. Further, as used herein, the words “a”, “an”, and the like include a meaning of “one or more”, unless stated otherwise. The drawings are generally drawn not to scale unless specified otherwise.

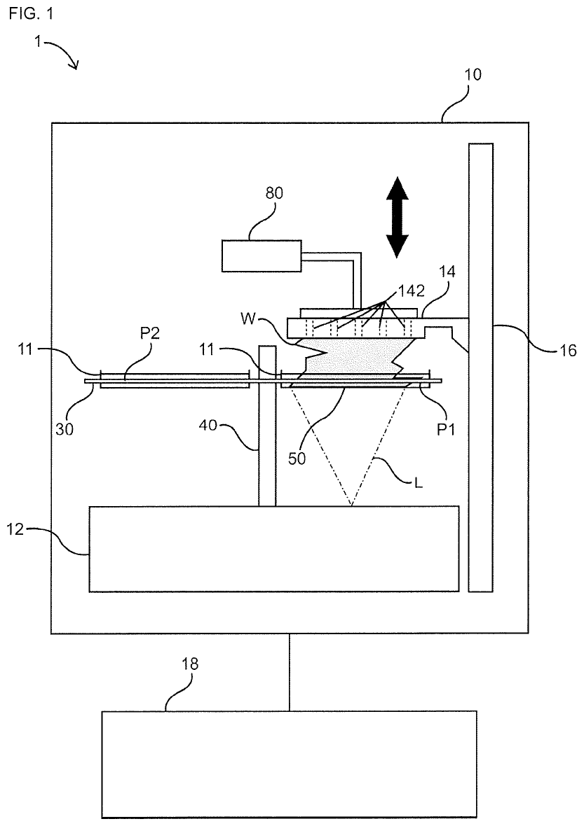

FIG. 1 is a schematic view of printer 1, according to certain aspects of the disclosure. Printer 1 is a device for manufacturing a 3D object, workpiece W. Printer 1 is provided with printer body 10 and controller 18. Printer body 10 includes items such as vats 11, digital light processing unit 12, movable stage 14, motor 16, vat loader 30, loader moving device 40, and vacuum generator 80. Printing processing by which printer 1 manufactures workpiece W is described in detail later.

Printer body 10 is housing for some of the items that configure printer 1. Vat 11 is for holding a photopolymer (for example, P1, P2) used for creating workpiece W. Vat 11 is a container with a bottom and side walls and an open top such that a stage can be inserted into the photopolymer loaded in vat 11 from above. Vats 11 may be provided with a lip (not shown) for support when inserted into a hole of vat loader 30 (described below). The bottom surface of vat 11 is transparent such that light from digital light processing unit 12 (described below) can reach the photopolymer in vat 11. The configuration of vat 11 is not particular limited, so long as it can hold a photopolymer and allow light from a digital light processing unit to reach the photopolymer. In printer 1, multiple vats 11 are provided, each holding a different photopolymer, such that workpiece W can be manufactured from multiple materials.

Vats 11 are loaded on vat loader 30. Vat loader 30 is a turntable with holes for receiving vats 11 and is provided with loader moving device 40. The holes for receiving vats 11 may be of an appropriate size such that a lip of vat 11 is supported by the edge of the hole. Vat loader 30 may also be provided with an adjustable supporting mechanism such as screws or the like to support vats of various sizes. Loader moving device 40 rotates vat loader 30 such that each of the multiple vats 11 can be moved to a stage receiving position (50) at which movable stage 14 is lowered into the vat 11 (in FIG. 1, the vat on the right is at stage receiving position 50). In printer 1, vat loader 30 is configured as a turntable that is rotated by loader moving device 40, but the configuration is not limited to this. The vat loader may be a rectangular plate or the like and the loader moving device may move the vats to the stage receiving position via conveyors, rollers, or the like. Alternatively, the loader moving device may exchange vats at the stage receiving position using a robot arm or the like that grips the vat using a mechanical claw. However, an advantage of using a turntable as loader moving device 40 is that this enables accurate positioning of vats 11 at the stage receiving position with a relatively simple mechanism with cheap manufacturing costs. In particular, such a configuration enables good accuracy to be maintained in the vertical direction, which is important for printing processing accuracy. Note that, accuracy levels required by such printers are often in a range of 10 to 100 microns.

Digital light processing unit 12 is used during printing processing to harden successive layers of the photopolymer in vat 11 to create workpiece W. Such units are well-known and a conventional digital light processing unit may be employed. For example, digital light processing unit 12 includes a light source and light adjustment mechanism (not shown), and hardens a layer of the workpiece W being created by applying light L to the photopolymer in vat 11 from below, through the transparent bottom of vat 11. Digital light processing unit 12 receives instructions from controller 18 and adjusts the light being applied to vat 11 based on these instructions. For example, the light L may be adjusted based on information regarding the layer to be created such as shape, position, and surface area.

Movable stage 14 is attached to frame 90 to be movable in a vertical direction (shown by the two-headed arrow in FIG. 1). Movable stage 14 is moved vertically by a moving device, for example, motor 16. During printing processing of workpiece W, movable stage is lowered by motor 16 until a bottom surface of movable stage 14 is inside a photopolymer in vat 11. When a layer of the photopolymer has been hardened by digital light processing unit 12, based on instructions from controller 18, motor 16 is driven at a given torque to raise movable stage 14. This processing is repeated layer by layer until the entire workpiece W is complete. Details regarding printing processing are described later.

Movable stage 14 is also provided with multiple holes 142. Holes 142 are open at the bottom surface of movable stage 14. Holes 142 are connected to, for example, vacuum generator 80 such that negative pressure can be supplied to holes 142, either collectively or individually. By applying negative pressure to holes 142, workpiece W being created on movable stage 14 is held more securely to movable stage 14, which prevents workpiece W from falling during printing processing. For example, this enables movable stage 14 to be raised at a faster speed, thus improving the efficiency of printing processing. Negative pressure to holes 142 may be controlled individually based on instructions from controller 18. For example, by adjusting to which holes 142 negative pressure is applied based on a shape, position, surface area, and the like of a layer of workpiece W that contacts the bottom surface of movable stage 14, it is possible to efficiently supply negative pressure while securely holding the workpiece W being created to movable stage 14. The force holding workpiece W to the bottom surface of the stage is particularly important when considering the force holding the newly created layer of workpiece W to the bottom surface of the vat. This force will also vary depending on a shape, position, surface area, and the like of the current layer (the layer contacting the bottom surface of the vat). As such, both a shape, position, surface area, and the like of a layer of workpiece W that contacts the bottom surface of movable stage 14 and a shape, position, surface area, and the like of the current layer may be considered when deciding, for example, the required holding force of workpiece W and the moving speed of movable stage 14. Details regarding varying of the moving speed of movable stage 14 are described later.

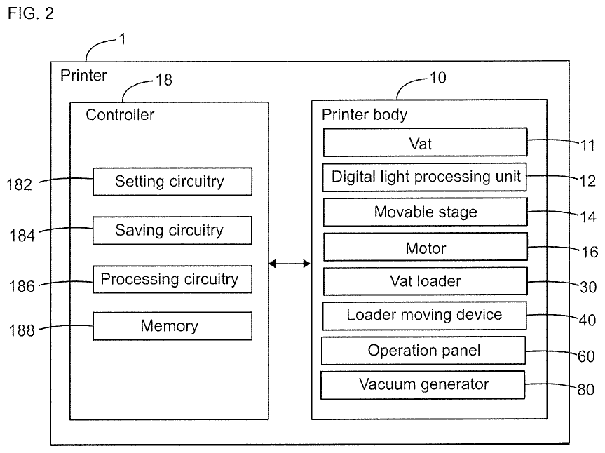

FIG. 2 is a block diagram showing the overall configuration of printer 1, according to certain aspects of the disclosure.

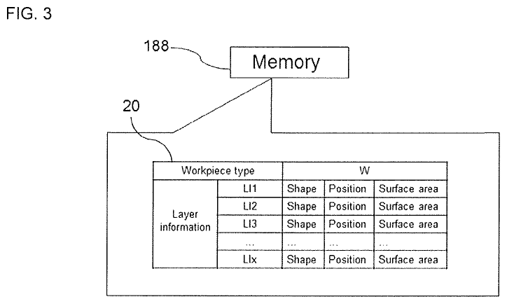

As shown in FIG. 2, printer 1 also includes operation panel 60 (not shown in FIG. 1). Operation panel 60 is used to display information to an operator and to receive inputs such as entry of job data 20 (refer to FIG. 3) and instructions to start or stop printing processing.

Controller 18 performs overall control of printer 1. Controller 18 may include items such as setting circuitry 182, saving circuitry 184, processing circuitry 186, and memory 188. Controller 18 may be configured from a general purpose computer or the like, including items such as a CPU, ROM, RAM, and an HDD. Memory 188 of controller 18 stores information such as job data 20 used during printing processing. Job data 20 may be entered by an operator using operation panel 60. Details regarding job data 20 are given below.

Processing circuitry 186 performs processing during printing processing of printing workpiece W based on job data 20. Saving circuitry 184 saves information generated during printing processing, such as a torque value of motor 16. Setting circuitry 182 is used by controller 18 to set values such as separation threshold value ST and falling threshold value FT used during printing processing. Details regarding such threshold values, other information used, and printing processing are given below.

FIG. 3 is a table showing an example of job data 20, according to certain aspects of the disclosure. Job data 20 is used during printing processing used to create workpiece W, and includes, for example, information regarding a workpiece type that defines the type of 3D object being created, and layer information LI. Layer information LI includes information of each layer, from LI1 to LIx, of the workpiece type. Each LI1 to LIx contains, for example, information representing a shape, a position, and a surface area of that layer. This information is used by digital light processing unit 12 to appropriately adjust the light applied to vat 11. This information may also be used by controller 18 to control the supply of negative pressure to holes 142 of movable stage 14.

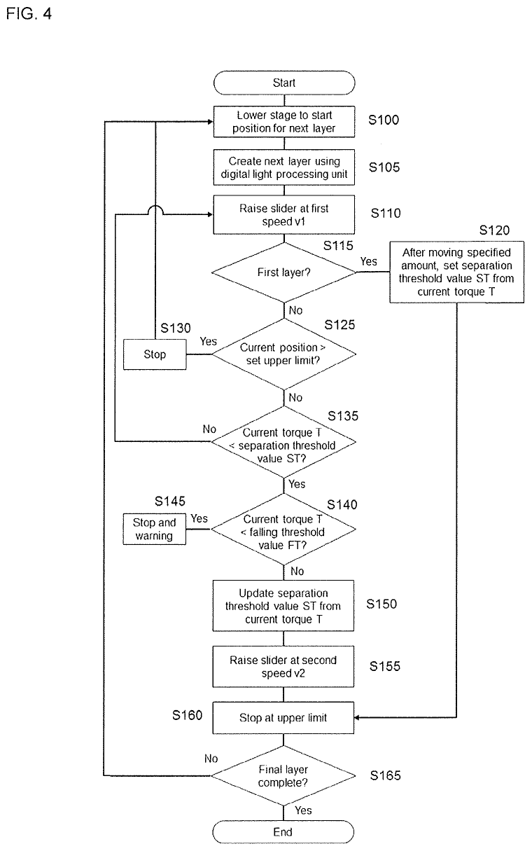

FIG. 4 shows a flowchart of an example of printing processing. Printing processing will now be described in detail with reference to FIG. 4.

The printing processing of FIG. 4 is performed by controller 18. After receiving an instruction from an operator to start printing processing, in S100, controller 18 controls motor 16 such that movable stage is lowered into vat 11 to the start position for the next layer.

Next, in S105, controller 18 controls digital light processing unit 12 to apply light to a layer of the photopolymer in vat 11 based on layer information LI of a first layer of the 3D object being created, as defined in job data 20 (refer to FIG. 3).

Then, in S110, controller 18 controls motor 16 to raise movable stage 14 at a first speed, v1. Note that, first speed v1 may be determined in advanced based on, for example, the material being used as a photopolymer, and the size, shape, weight, layer surface area, and so on of the workpiece W being created.

Then, in S115, controller 18 determines whether the created layer was the first layer of the 3D object based on job data 20. If determining “Yes” in S115, controller 18 proceeds to S120, in which, after raising movable stage 14 by a specified amount, controller 18 uses setting circuitry 182 to set separation threshold value ST based on a current torque value received from motor 16. Note that, the torque value may be received from motor 16, for example, based on information from an encoder of motor 16. Controller 18 then proceeds to S155, wherein movable stage 14 is stopped at a predetermined upper limit.

If controller 18 determines “No” in S115, processing proceeds to S125. In S125, controller 18 determines if the current position of movable stage is greater than the predetermined upper limit. If determining “Yes” in S125, controller 18 stops operation of printer 1 (S130), then returns to S100. If determining “No” in S125, controller 18 proceeds to S135.

In S135, controller 18 determines whether the current torque of motor 16 is less than the currently set separation threshold value ST. If determining “No” in S135, controller 18 returns to S110. If determining “Yes” in S135, controller 18 proceeds to S140.

In S140, controller 18 determines whether the current torque value is less than a predetermined falling threshold value, FT. Note that, falling threshold value FT may be set in advance by setting circuitry 182 of controller 18, based on, for example, the material being used as a photopolymer, and the size, shape, weight, layer surface area, and so on of the workpiece W being created. If determining “Yes” in S140, controller 18 stops operation of printer 1 and issues a warning to an operator via operation panel 60 (S145). If determining “No” in S145, controller 18 proceeds to S150.

In S150, controller 18 updates separation threshold value ST based on the current torque of motor 16, then proceeds to S155.

In S155, controller 18 controls motor 16 to raise movable stage 14 at a second speed, v2, which is greater than v1. Note that, as with first speed v1, second speed v2 may be determined in advanced based on, for example, the material being used as a photopolymer, and the size, shape, weight, layer surface area, and so on of the workpiece being created.

Processing then proceeds to S160, where movable stage 14 is stopped at the upper limit. Then, in S165, controller 18 determines whether the final layer of the 3D object being created is complete. If determining “No” in S165, controller 18 returns to S100. If determining “Yes” in S165, controller 18 ends processing.

As described above, with printer 1, controller 18 is configured to control a speed of motor 16 (moving device) based on a torque value of motor 16. Thus, by appropriately controlling the speed of motor 16, movable table 14 is moved such that printing processing is performed efficiently and effectively, without the workpiece W being created falling from movable stage 14.

Further, with printer 1, movable stage 14 may be positioned above vat 11 and includes at least one hole 142, hole 142 being configured to assist holding of the created workpiece W via negative pressure being supplied via the at least one hole 142. Accordingly, the workpiece W is held more securely to movable stage 14 during printing processing, enabling faster printing processing while preventing the workpiece W being created falling from movable stage 14.

Also, with printer 1, when movable stage 14 includes multiple holes 142, controller may be configured to control supply of the negative pressure to each of the holes 142 individually based on a workpiece type of the workpiece W, as defined in work data 20.

Further, with printer 1, further provided may be: vat loader 30 on which multiple of the vats 11 are loadable, wherein each of the vats 11 contains a different photopolymer; and loader moving device 40 for moving vat loader 30. Movable stage 14 may be positioned above vat loader 30 and controller 18 may be configured to drive loader moving device 40 such that each of the multiple vats 11 are positioned one at a time at a position to receive the stage such that the workpiece W can be manufactured from different materials.

Further, printer 1 may also be provided with setting circuitry 182 configured to set separation threshold value ST that is a threshold to which to compare the torque value, and controller 18 may be configured to check whether the torque value exceeds the separation threshold value ST, and to control motor 16 to move at a first speed, v1, if the torque value is less than the separation threshold value ST. Accordingly, printer 1 achieves faster and more efficient printing processing.

Also, with printer 1, controller 18 may be also configured to use setting circuitry 182 to set falling threshold value FT that is a threshold to which to compare the torque value, and controller 18 may be configured to perform at least one of stopping operation or issuing a warning to an operator if the torque value is equal to or greater than falling threshold value FT, and to control motor 16 to move at a second speed, v2, if the torque value is less than falling threshold value FT, the second speed v2 being faster than the first speed v1. Accordingly, printer 1 achieves faster and more efficient printing processing.

With printer 1, controller 18 may be further configured to update separation threshold value ST based on a current torque value of motor 16 that is the torque value from after comparing with falling threshold value FT. This allows printing processing of subsequent layers to be performed more appropriately. Accordingly, printer 1 achieves faster and more efficient printing processing. With printer 1, controller 18 may also be configured to consider a surface area value of a current layer that is a layer currently being processed when setting at least one of separation threshold value ST or the falling threshold value FT. This allows separation value ST or falling threshold value to be set more appropriately, enabling faster printing processing while preventing the workpiece W being created falling from movable stage 14.

Further, according to another aspect of the disclosure, printer 1 is used to perform a three-dimensional object manufacturing method including: filling a vat with a photopolymer; applying light using a digital light processing unit to at least a portion of the photopolymer in the vat so as to create a layer of a three-dimensional object; using a moving device to move a movable stage relative to the vat containing the photopolymer; and controlling a speed of the moving device based on a torque value of the moving device. This method achieves the same benefits as that of printer 1.

The foregoing discussion discloses and describes exemplary embodiments of an object of the present disclosure. As will be understood by those skilled in the art, an object of the present disclosure may be embodied in other specific forms without departing from the spirit or essential characteristics thereof. Accordingly, the present disclosure is intended to be illustrative, but not limiting of the scope of an object of the present disclosure as well as the claims.

Numerous modifications and variations on the present disclosure are possible in light of the above teachings. It is therefore to be understood that within the scope of the appended claims, the disclosure may be practiced otherwise than as specifically described herein.

For example, although not shown in the figures, a tilting mechanism may be provided to tilt vat 11. In this manner, the peeling forces exerted on the 3D object being created as movable stage 14 is raised may be mitigated, such that damage to the 3D object is prevented. The tilting mechanism may also be controlled based on a torque value of motor 16 (moving device).

### REFERENCE SIGNS LIST

1: printer; 10: printer body 10: vat; 12: digital light processing unit; 14: movable stage; 142: hole; 16: motor; 18: controller; 182: setting circuitry; 184: saving circuitry; 186: processing circuitry; 188: memory; 20: job data; 30: vat loader; 40: loader moving device; 50: stage receiving position; 60: operation panel; 80: vacuum generator; L: light; P1, P2: photopolymer; T: torque; FT: falling threshold; ST: separation threshold; v1: first speed; v2: second speed; W: workpiece

1. A three-dimensional object manufacturing device comprising:
a vat configured to hold a photopolymer;
a digital light processing unit configured to apply light to at least a portion of the photopolymer in the vat so as to create a layer of a three-dimensional object;
a movable stage configured to be movable relative to the vat containing the photopolymer;
a moving device configured to move the stage; and
a controller configured to control a speed of the moving device based on a torque value of the moving device.

2. The three-dimensional object manufacturing device according to claim 1, wherein:
the movable stage is positioned above the vat and includes at least one hole, the hole being configured to assist holding of the created three-dimensional object via negative pressure being supplied via the at least one hole.

3. The three-dimensional object manufacturing device according to claim 2, wherein:
the movable stage includes multiple of the holes, the holes being configured to assist holding of the created three-dimensional object via negative pressure being supplied via the holes, and
the controller is configured to control supply of the negative pressure to each of the holes individually based on a type of the three-dimensional object being manufactured.

4. The three-dimensional object manufacturing device according to claim 1, further comprising:
a vat loader on which multiple of the vats are loadable, each of the vats containing a different photopolymer;
a loader moving device for moving the vat loader;
wherein
the movable stage is positioned above the vat loader, and
the controller is configured to drive the loader moving device such that each of the multiple vats are positioned one at a time at a position to receive the stage such that the three dimensional object can be manufactured from different materials.

5. The three-dimensional object manufacturing device according to claim 1, further comprising:
a vat loader on which multiple of the vats are loadable, each of the vats containing a different material;
a loader moving device for moving the vat loader;
wherein
the movable stage is positioned above the vat loader, and
the movable stage is positioned above the vat and includes a hole, the hole being configured to assist holding of the created three-dimensional object via negative pressure being supplied via the hole,
the controller is configured to drive the loader moving device such that each of the multiple vats are positioned one at a time at a position to receive the stage such that the three dimensional object can be manufactured from different materials.

6. The three-dimensional object manufacturing device according to claim 1, further comprising:
setting circuitry configured to set a separation threshold value that is a threshold to which to compare the torque value,
wherein,
the controller is configured to check whether the torque value exceeds the separation threshold value, and to control the moving device to move at a first speed if the torque value is less than the separation threshold value.

7. The three-dimensional object manufacturing device according to claim 6, wherein:
the setting circuitry is further configured to set a falling threshold value that is a threshold to which to compare the torque value, and
the controller is configured to perform at least one of stopping operation or issuing a warning to an operator if the torque value is equal to or greater than the falling threshold value, and to control the moving device to move at a second speed if the torque value is less than the falling threshold value, the second speed being faster than the first speed.

8. The three-dimensional object manufacturing device according to claim 7, wherein:
the controller is further configured to update the separation threshold value based on a current torque value that is the torque value from after comparing with the falling threshold value.

9. The three-dimensional object manufacturing device according to claim 8, wherein:
the controller is further configured to consider a surface area value of a current layer that is a layer currently being processed when setting at least one of the separation threshold value or the falling threshold value.

10. A three-dimensional object manufacturing method comprising:
filling a vat with a photopolymer;
applying light using a digital light processing unit to at least a portion of the photopolymer in the vat so as to create a layer of a three-dimensional object;
using a moving device to move a movable stage relative to the vat containing the photopolymer; and
controlling a speed of the moving device based on a torque value of the moving device.
